(19) United States
(12) Patent Application Publication
(10) Pub. No.: US 2026/0149384 A1
(43) Pub. Date: May 28, 2026

(54) HYBRID TRANSFORMER APPARATUS AND CONTROL METHOD THEREOF

(71) Applicant: Industrial Technology Research Institute, Hsinchu (TW)

(72) Inventors: Shao-Wei PENG, Xinfeng Township (TW); Po-Li CHEN, Erlin Township (TW)

(73) Assignee: Industrial Technology Research Institute, Hsinchu (TW)

(21) Appl. No.: 18/978,605

(22) Filed: Dec. 12, 2024

(30) Foreign Application Priority Data
Nov. 28, 2024 (TW) 113145928

(51) Int. Cl. H02M 5/458; H02M 1/32

(52) U.S. Cl. CPC H02M 5/458; H02M 1/32

(57) ABSTRACT

A hybrid transformer apparatus and a control method thereof are provided. The hybrid transformer apparatus includes at least one power electronic module having a parallel converter and a series converter electrically connected to form a hybrid converter. The parallel converter is electrically connected to the low voltage side of a distribution transformer. A controller controls the signals of the parallel converter and the series converter, including switching switches, a bypass circuit, and a compensation transformer. The controller reduces load voltage variation in response to changes in input voltage. A communication device transmits voltage and current information to the controller. The hybrid transformer apparatus also includes a circuit breaker and a bypass circuit.

### CROSS REFERENCE TO RELATED APPLICATIONS

This Application claims priority of Taiwan Patent Application No. 113145928, filed on Nov. 28, 2024, the entirety of which is incorporated by reference herein.

### TECHNICAL FIELD

### Field of the Invention

This disclosure relates to hybrid transformer apparatuses and control methods. In particular, this disclosure relates to a hybrid transformer apparatus and a control method with modular capacity expansion capability and equal watt control for improving feeder voltage compensation capability and power supply quality.

### BACKGROUND

The increasing use of renewable energy sources, such as solar power, and the widespread adoption of electric vehicles pose significant challenges to the power quality of distribution feeders. Excessive generation of renewable energy can lead to grid overload, forcing residential solar power systems to curtail or cease power export. High charging demand from electric vehicles can also cause significant voltage drops in the feeder, affecting power stability.

Conventional distribution transformers, while simple, efficient, and reliable, are limited in their ability to address these challenges. Their inherent functional limitations hinder their ability to maintain feeder quality and provide flexible regulation under the dynamic conditions of future power grids.

Thus, a need exists for a new type of hybrid transformer apparatus and control method to address these issues and improve feeder voltage compensation capability and power supply quality.

### SUMMARY

One embodiment of this disclosure describes a hybrid transformer apparatus that includes at least one power electronic module. The power electronic module includes a parallel converter and a series converter electrically connected to each other to form a hybrid converter. The parallel converter is electrically connected to the low voltage side of a distribution transformer. The series converter includes a first switching switch, a second switching switch, a third switching switch, a fourth switching switch, and a compensation transformer. The apparatus also includes a controller that controls the signals of the parallel converter and the series converter based on the number of power electronic modules. The controller reduces variations in load voltage in response to changes in input voltage. A communication device transmits voltage and current information to the controller. A circuit breaker cuts off an input power source of the power electronic modules. A bypass circuit that includes a relay, a silicon controlled rectifier (SCR), and a surge absorber (MOV) performs a fault protection operation when the hybrid converter fails.

In one embodiment, a control method for a hybrid transformer apparatus is provided, wherein the controller included in the hybrid transformer apparatus is caused to perform the following steps: a voltage equalization calculation step of using a peak command detection method to find a maximum voltage value in the power electronic modules, using the maximum voltage value as a reference command voltage followed by each of the power electronic modules, and obtaining a voltage feedback value for each of the power electronic modules, and comparing the voltage feedback value with the reference command voltage; an undervoltage/overvoltage determination step of performing a calculation with an effective value of the voltage feedback value, then performing undervoltage and overvoltage condition determination, and adjusting a compensation command value according to a determination result; and a compensation control step of individually activating the series converter in the power electronic modules and a compensation control loop according to a result of the undervoltage/overvoltage determination step.

The hybrid transformer apparatus according to in some embodiments this disclosure can increase capacity and compensation range requirements through modular settings. Additionally, due to the introduction of equal watt control in the modules, the compensation output power can be evenly distributed, reducing heavy load conditions on a single unit.

The hybrid transformer apparatus in some embodiments of this disclosure utilizes hybrid distribution transformer (HDT) technology, combining parallel and series converters to provide the power quality compensation and voltage regulation functions required by the feeder.

The hybrid transformer apparatus in some embodiments of this disclosure utilizes HDT technology, integrating power electronics technology with increased capacity and a conventional transformer. This integration provides the power quality compensation required by the feeder while possessing the advantages of high reliability of the conventional transformer and high controllability of the power electronic device.

### BRIEF DESCRIPTION OF THE DRAWINGS

The disclosure can be more fully understood by reading the subsequent detailed description and examples with references made to the accompanying drawings, wherein:

FIG. 1A shows a schematic diagram of a module circuit of a hybrid transformer apparatus according to one embodiment.

FIG. 1B shows a schematic diagram of a circuit architecture of a hybrid transformer apparatus according to one embodiment.

FIG. 2 shows a schematic diagram of a system circuit of the hybrid transformer apparatus.

FIG. 3A shows a schematic diagram of a control flow of the hybrid transformer apparatus and the control method thereof.

FIG. 3B shows a timing diagram of main voltage waveforms in the control flow of the hybrid transformer apparatus and the control method thereof.

FIG. 4 shows a schematic diagram of a system startup control flow of the hybrid transformer apparatus and the control method thereof.

FIG. 5 shows a schematic diagram of a system compensation and voltage equalization control flow of the hybrid transformer apparatus and the control method thereof.

FIG. 6 shows a schematic diagram of a system bypass control flow of the hybrid transformer apparatus.

### DETAILED DESCRIPTION

The following description is made for the purpose of illustrating the general principles of the disclosure and should not be taken in a limiting sense. The scope of the disclosure is best determined by reference to the appended claims.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

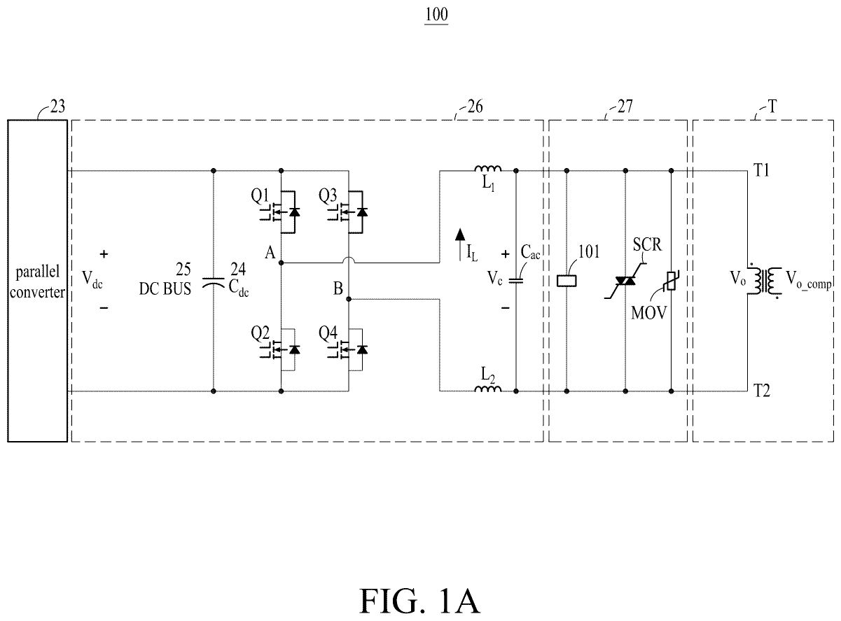

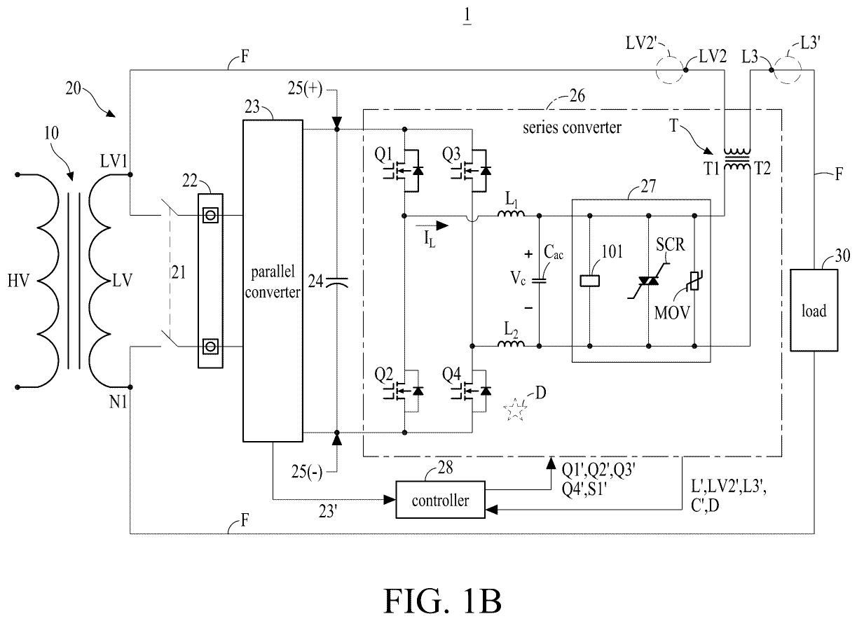

FIG. 1A is a schematic diagram of a module circuit of a hybrid transformer module in a hybrid transformer apparatus according to one embodiment.

As shown in FIG. 1A, in one embodiment, the hybrid transformer module 100 of this disclosure includes a parallel converter 23, a series converter 26, a bypass and surge absorption circuit 27, and a compensation transformer T, but is not limited thereto.

As shown in FIG. 1B, in another embodiment, a hybrid transformer apparatus 1 may include a distribution transformer 10 and at least one power electronic module 20 electrically connected to each other.

In one embodiment, the distribution transformer 10 has a high voltage side HV and a low voltage side LV opposite to each other, the power electronic module 20 has a parallel converter 23 and a series converter 26 electrically connected to each other, and the parallel converter 23 is electrically connected to the low voltage side LV of the distribution transformer 10.

In one embodiment, the distribution transformer 10 may be a conventional distribution transformer, a center tap distribution transformer, or the like. The power electronic module 20 may be a power electronic circuit, a power electronic converter (such as a Heric power electronic converter), or the like, the circuit breaker 21 may be a disconnect switch or the like, and the first connection terminal 22 or the second connection terminal 27 may be a connector or the like. The parallel converter 23 may be a photovoltaic (PV) converter, an energy storage device, an AC/DC converter, or the like from various sources.

In one embodiment, a first end point LV1 (such as a hot wire end point) and a second end point N1 (such as a neutral wire end point) of the low voltage side LV of the distribution transformer 10 are respectively electrically connected to the power electronic module 20. For example, the high voltage side HV of the distribution transformer 10 may have a high voltage such as 22.8 kilovolts (kV), 11.4 kilovolts (kV), or 6.9 kilovolts (kV), and the low voltage side LV of the distribution transformer 10 may have a low voltage such as 220 volts (V) or 110 volts (V).

In one embodiment, the power electronic module 20 may have a circuit breaker 21, a first connection terminal 22, a parallel converter 23, a capacitor 24, a DC voltage bus 25, a series converter 26, a controller 28, and the like, and the series converter 26 may have a first switching switch Q1, a second switching switch Q2, a third switching switch Q3, a fourth switching switch Q4, a bypass and surge absorption circuit 27, and a compensation transformer T. In one embodiment, it can be considered that the power electronic module 20 includes a parallel converter 23, a capacitor 24, a DC voltage bus 25, and a series converter 26 constituting the hybrid transformer module 100, and the series converter 26 includes a surge absorption circuit 27 and a compensation transformer T.

In one embodiment, the parallel converter 23 can establish (generate) a rated DC voltage Vdc on a positive terminal (+) and a negative terminal (−) of a DC bus 25, the parallel converter 23 can be sequentially connected in parallel to the low voltage side LV and a feeder F of the distribution transformer 10 through the first connection terminal 22 and the circuit breaker 21, and the parallel converter 23 is electrically connected to the capacitor 24, the DC voltage bus 25, the first switching switch Q1 to the fourth switching switch Q4, and the controller 28 included in the series converter 26.

In one embodiment, the series converter 26 includes a plurality of switching switches (for example, the first switching switch Q1 to the fourth switching switch Q4) for performing pulse width modulation (PWM) control to adjust an output voltage of the compensation transformer, thereby stabilizing a load voltage.

In one embodiment, the series converter 26 has a capacitor 24, a first switching switch Q1, a second switching switch Q2, a third switching switch Q3, a fourth switching switch Q4, a node A, a node B, an inductor L1, an inductor L2, and a capacitor Cac.

In one embodiment, the capacitor 24 may be an electrolytic capacitor or the like, storing DC energy and maintaining voltage stability of the DC voltage bus 25, and the DC voltage bus 25 provides a DC voltage required by the series converter 26, but is not limited thereto.

In one embodiment, any one of the first switching switch Q1 to the fourth switching switch Q4 may be an insulated gate bipolar transistor (IGBT), a metal-oxide-semiconductor field-effect transistor (MOSFET), a wide band gap (WBG) switching switch (such as WBG MOSFET), or the like.

In one embodiment, a positive terminal (+) of the DC voltage bus 25 can be electrically connected to the drain of the first switching switch Q1 and the drain of the third switching switch Q3, and a negative terminal (−) of the DC voltage bus 25 can be electrically connected to the source of the second switching switch Q2 and the source of the fourth switching switch Q4. One end of the capacitor 24 can be respectively electrically connected to the parallel converter 23, the positive terminal (+) of the DC voltage bus 25, the drain of the first switching switch Q1, and the drain of the third switching switch Q3, and the other end of the capacitor 24 can be respectively electrically connected to the parallel converter 23, the negative terminal (−) of the DC voltage bus 25, the source of the second switching switch Q2, and the source of the fourth switching switch Q4.

The first switching switch Q1 can be electrically connected to the second switching switch Q2 and the third switching switch Q3 via the node A, and both the first switching switch Q1 and the third switching switch Q3 can be electrically connected to the parallel converter 23, the capacitor 24, and the positive terminal (+) of the DC voltage bus 25. The second switching switch Q2 can be electrically connected to the first switching switch Q1 and the fourth switching switch Q4, and both the second switching switch Q2 and the fourth switching switch Q4 can be electrically connected to the parallel converter 23, the capacitor 24, and the negative terminal (−) of the DC voltage bus 25. For example, the source of the first switching switch Q1 can be electrically connected to the drain of the second switching switch Q2, the drain of the first switching switch Q1 can be electrically connected to the drain of the third switching switch Q3, the source of the second switching switch Q2 can be electrically connected to the source of the fourth switching switch Q4, the source of the third switching switch Q3 can be electrically connected to the drain of the fourth switching switch Q4 via the node B, and the first switching switch Q1 to the fourth switching switch Q4 can form an H-bridge switch structure.

In one embodiment, the first switching switch Q1 to the fourth switching switch Q4 form an H-bridge switch structure, and output is adjusted by performing pulse width modulation (PWM) control through switching actions.

In one embodiment, a current I_{L} is output to one end of an inductor L1 via the node A, and the other end of the inductor L1 is connected to a first end point T1 of the compensation transformer T, but is not limited thereto.

In one embodiment, one end of an inductor L2 is connected to the node B, and the other end of the inductor L2 is connected to a second end point T2 of the compensation transformer T, but is not limited thereto.

Both ends of the capacitor Cac can be respectively electrically connected to the other ends of the inductors L1 and L2. One end of the capacitor Cac can be electrically connected to the second end of the inductor L1 and the first end point T1 of the compensation transformer T, and the other end of the capacitor Cac can be electrically connected to the other end of the inductor L2 and the second end point T2 of the compensation transformer T. That is, the other ends of the two inductors L1 and L2 can be first connected in parallel to both ends of the capacitor Cac, and then respectively electrically connected to the first end point T1 and the second end point T2 of the compensation transformer.

As shown in FIG. 1A, in one embodiment, the bypass and surge absorption circuit 27 includes a relay 101, a silicon controlled rectifier (SCR), and a metal oxide varistor (MOV). The main function of the bypass and surge absorption circuit 27 is to provide a bypass function and a protection device, but is not limited thereto.

In one embodiment, the relay 101 is a switch element that controls a bypass function. When it is necessary to bypass the series converter, the relay 101 is closed so that a current directly flows through a bypass circuit, but is not limited thereto.

In one embodiment, the silicon controlled rectifier SCR and the metal oxide varistor MOV form a surge protection circuit. When a surge voltage appears in the circuit, the silicon controlled rectifier SCR is turned on, and a surge current is introduced into the metal oxide varistor MOV for absorption. The metal oxide varistor MOV can absorb the surge voltage, protect circuit elements, and further protect a back-end circuit, but is not limited thereto.

In one embodiment, the controller 28 may be a microcontroller unit (MCU) or the like, and the feeder F may be a power line, a distribution line, a transmission line, or the like.

In one embodiment, both ends of the circuit breaker 21 of the power electronic module 20 can be respectively connected in parallel to a first end point LV1 (such as a hot wire end point) and a second end point N1 (such as a neutral wire end point) of the low voltage side LV of the distribution transformer 10, both ends of the first connection terminal 22 can be respectively electrically connected to both ends of the circuit breaker 21, and the circuit breaker 21 can be sequentially electrically connected to the first connection terminal 22 and the parallel converter 23.

In one embodiment, the first end point T1 of the compensation transformer T can be electrically connected to the second side of the inductor L1 and one end of the capacitor Cac, and the second end point T2 of the compensation transformer T can be electrically connected to the second side of the inductor L2 and the other end of the capacitor Cac. A third end point LV2 of the compensation transformer T can be electrically connected to the first end point LV1 of the low voltage side LV of the distribution transformer 10 through the feeder F, and a fourth end point L3 of the compensation transformer T and the second end point N1 of the low voltage side LV of the distribution transformer 10 can be respectively electrically connected to both ends of the load 30 through the feeder F. That is, the first end point LV1 of the low voltage side LV of the distribution transformer 10 can be electrically connected to the third end point LV2 of the compensation transformer T, and output ends of the hybrid transformer apparatus 1 are the fourth end point L3 of the compensation transformer T and the second end point N1 of the low voltage side LV of the distribution transformer 10 to be electrically connected to both ends of the load 30, respectively.

The controller 28 can be respectively electrically connected to the parallel converter 23, the DC voltage bus 25, the first switching switch Q1 to the fourth switching switch Q4, the bypass and surge absorption circuit 27, and the like, and the controller 28 can respectively generate a first switching switch signal Q1′ to a fourth switching switch signal Q4′, and a bypass and surge absorption circuit signal S1′ to correspondingly control the first switching switch Q1 to the fourth switching switch Q4 and the bypass and surge absorption circuit 27, respectively.

The controller 28 can receive an operation signal 23′ (such as a circuit normal return signal) of the parallel converter 23 to monitor whether the parallel converter 23 is operating normally (such as whether an abnormal state occurs) according to the operation signal 23′, and the controller 28 can also monitor whether the parallel converter 23 has established a rated DC voltage (such as a DC voltage of 380 or 400 volts) on the positive terminal (+) and the negative terminal (−) of the DC voltage bus 25. The controller 28 can receive a voltage signal C′ of the capacitor Cac, a voltage signal LV2′ before adjustment of the feeder F (such as a voltage between the third end point LV2 of the compensation transformer T and the second end point N1 of the low voltage side LV of the distribution transformer 10), a voltage signal L3′ after adjustment of the feeder F (such as a voltage between the fourth end point L3 of the compensation transformer T and the second end point N1 of the low voltage side LV of the distribution transformer 10), a current signal L′ of the inductors L1 and L2, and can also receive a temperature signal D of the series converter 26 (such as at least one of the first switching switch Q1 to the fourth switching switch Q4 and the bypass and surge absorption circuit 27).

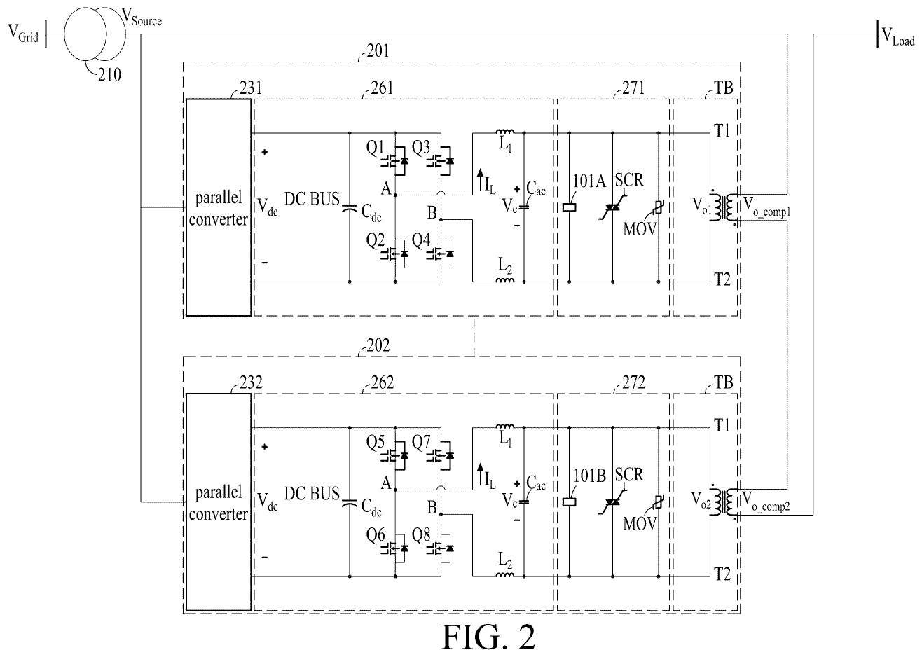

As shown in FIG. 2, a system circuit diagram of the hybrid transformer apparatus in some embodiments is shown.

In FIG. 2, the system circuit of the hybrid transformer apparatus adopts a modular control strategy, allowing at least two power electronic modules to operate in series to improve system capacity and reliability.

In one embodiment, one side of the distribution transformer 210 is connected to a grid voltage VGrid, and the other side is connected to a power supply voltage VSource, but is not limited thereto.

As shown in the FIG. 2, the system circuit forms series compensation, a compensation transformer TB of the power electronic module 201 and a compensation transformer TB of the power electronic module 202 are connected in series, sharing the same output current, and an output voltage of each module is automatically adjusted according to a feeder voltage demand.

The control method of one embodiment in the disclosure adopts equal watt control so that each power electronic module shares the load equally, improving system efficiency and service life. In one embodiment, series equal watt control is adopted, and the controller 28 adjusts a PWM control signal according to an output voltage of each power electronic module 201 and 202 so that output power of each module is equally allocated.

More specifically, the power electronic module 201 includes a parallel converter 231, a series converter 261, a bypass and surge absorption circuit 271, and a compensation transformer TB. The power electronic module 202 includes a parallel converter 232, a series converter 262, a bypass and surge absorption circuit 272, and a compensation transformer TB.

In one embodiment, one end of a secondary side of the compensation transformer TB of the power electronic module 201 is connected to a power supply voltage VSource, the other end of the secondary side of the compensation transformer TB of the power electronic module 201 is connected to one end of a secondary side of the compensation transformer TB of the power electronic module 202 to form a series structure, and the other end of the secondary side of the compensation transformer TB of the power electronic module 202 outputs a load voltage V_{LOAD}, but is not limited thereto.

In one embodiment, the series converters 261 and 262 include a first switching switch Q1 to a fourth switching switch Q4, and a fifth switching switch Q5 to an eighth switching switch Q8 for performing pulse width modulation (PWM) control to adjust output voltages of the compensation transformer TB of the power electronic module 201 and the compensation transformer TB of the power electronic module 202, thereby stabilizing the load voltage V_{LOAD}. An output end of the series converter 261 is connected to a primary side of the compensation transformer TB of the power electronic module 201; an output end of the series converter 262 is connected to a primary side of the compensation transformer TB of the power electronic module 202.

Secondary sides of the compensation transformer TB of the power electronic module 201 and the compensation transformer TB of the power electronic module 202 are connected in series on the feeder for compensating a feeder voltage drop. The compensation transformer TB of the power electronic module 201 and the compensation transformer TB of the power electronic module 202 are connected in series, sharing the same output current, and an output voltage of each module is automatically adjusted according to the feeder voltage demand to jointly maintain stability of the load voltage V_{LOAD}.

In one embodiment, the power electronic modules 201 and 202 also include bypass and surge absorption circuits 271 and 272 for providing a bypass function and a protection device. When a certain power electronic module fails or needs maintenance, the power electronic module can be isolated through the bypass function, and other modules can still continue to operate, ensuring reliability of power supply.

Through the above configuration, system capacity, reliability, and efficiency can be effectively improved, and the configuration is applicable to various distribution systems to improve grid-connected stability of renewable energy, improve charging efficiency of electric vehicles, stabilize feeder voltage, and reduce power loss.

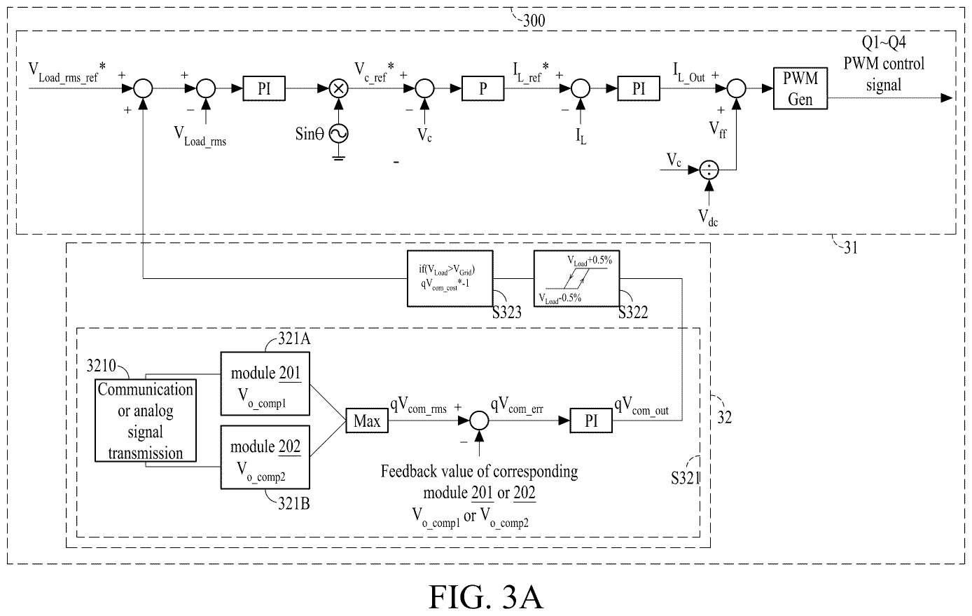

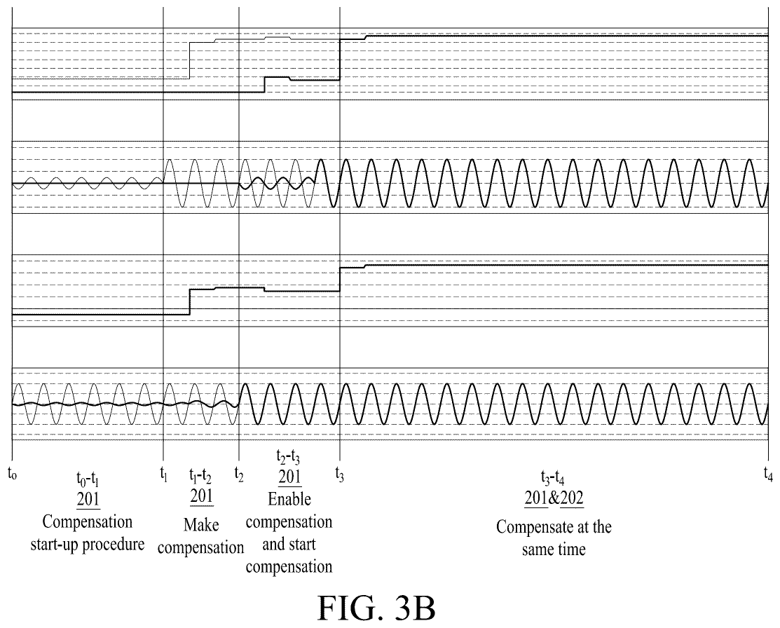

As shown in FIG. 3A, a control flow diagram of a series converter control loop 30 in the hybrid transformer apparatus according to some embodiments is shown.

Taking two modules as an example, feedback voltage information of each module is exchanged through communication or an analog signal, and a controller of each module compares a maximum value as a reference command, and then the reference command is sent to an overall flow of a control loop of each module.

In the control flow shown in FIG. 3A, the series converter control loop 300 mainly includes two loops: a compensation control loop 31 and a voltage equalization control loop 32. In one embodiment, the series converter control loop 30 is responsible for controlling an output voltage and a current of the series converter to achieve a required voltage compensation effect.

In one embodiment, the compensation control loop 31 receives a load voltage reference value V_Load_rms_ref* as an input, adds the load voltage reference value to an output of the voltage equalization control loop 32 through an adder, subtracts a root mean square value V_{Lord_rms} of the load voltage through a subtracter, generates a voltage compensation amount through a proportional integral controller PI, adjusts a phase of the compensation amount through a multiplier by a sine wave generator Sin θ, inputs a obtained capacitor voltage reference value V_{C_ref*} to a proportional controller P after subtracting a capacitor voltage VC through a subtracter to obtain an inductor current reference value I_{L_ref*}, subtracts an inductor current I_{L} through a subtracter, obtains an inductor current output value I_{L_Out} through a proportional integral controller PI, adds the inductor current output value to a feedback voltage V_{ff} through an adder, where the feedback voltage V_{ff} is obtained by dividing the capacitor voltage Vc by a DC voltage Vdc, and uses an output obtained by adding the inductor current output valueI_{L_Out} to the feedback voltage V_{ff} as an output of a PWM generator (PWM Gen) to generate a PWM control signal of the first switching switch Q1 to the fourth switching switch Q4.

In one embodiment, the voltage equalization control loop 32 is responsible for balancing output power of each module to improve system efficiency and extend service life of the module.

In one embodiment, the voltage equalization control loop 32 sequentially performs the following steps:

Voltage equalization calculation step S321: receiving feedback voltage information (for example, a secondary side voltage Vo_comp1, Vo_comp2 or a primary side voltage Vo1, Vo2 of the compensation transformer TB of the power electronic module 201, and the compensation transformer TB of the power electronic module 202) of each module 321A and 321B through communication or an analog signal transmitted to the controller 28, comparing a maximum value as a command voltage root mean square value qVcom_rms through a maximum value selector Max, then subtracting a feedback value of another corresponding module, calculating an error signal qV_com_err, and then inputting the error signal to a proportional integral controller PI to generate a control signal qV_com_out according to the error signal.

Hysteresis determination step S322: using the control signal qV_com_out as an input to the hysteresis determination step S322 and outputting the control signal to an undervoltage/overvoltage determination step S323.

Undervoltage/overvoltage determination step S323: monitoring an output voltage of the module through an undervoltage/overvoltage determination formula 323. If the voltage exceeds a preset safety range, a protection mechanism is triggered, for example, stopping operation of the module. In one embodiment, an output of the undervoltage/overvoltage determination step S323 is used as an output of the voltage equalization control loop to ensure that the output voltage of each module is within the safety range and improve system stability.

Here, the master-slave control mainly uses communication or an analog signal to exchange compensation voltage information of each module. Taking two modules as an example, the voltage equalization control loop 32 follows a higher value of the compensation voltage. A maximum value followed exceeds an average voltage, causing a total compensation voltage to be greater than a target value. An excess portion is adjusted back by the compensation control loop 31. Therefore, the voltage equalization control loop 32 causes a compensation voltage difference between the modules to converge, and finally follows an average voltage value. Through such a configuration, even in a case where there are a majority of modules or some modules are in a bypass state, the voltage equalization control loop 32 can achieve voltage equalization control.

As shown in FIG. 3B, a timing diagram of main voltage waveforms in the control flow of the hybrid transformer apparatus and the control method thereof is shown.

In one embodiment, as shown in the FIG. 3B, two modules S1 and S2 perform series compensation. In a time point t0-t1, neither the power electronic module 201 nor the power electronic module 202 (hereinafter also referred to as modules S1 and S2) performs compensation. The module S1 performs transformer short circuit by a circuit switch, and the module S2 performs transformer short circuit by a bypass switch. In a time point t1-t2, the module S1 starts to perform compensation, and the load voltage is compensated from, for example, 200V to 208V. In a time point t2-t3, the module S2 also starts to perform compensation, and then the load voltage is compensated from, for example, 208V to 216V. Here, it can be seen that both modules perform compensation in a time after the time point t3. Therefore, it can be seen from waveforms Vo_S1 and Vo_S2 that compensation voltages of the two modules are the same, achieving an effect of voltage equalization control.

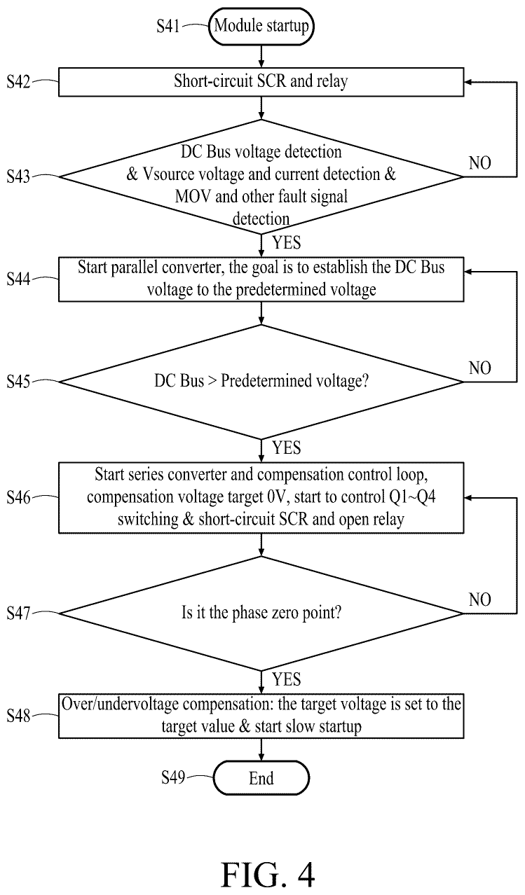

As shown in FIG. 4, a system startup control flow diagram of the hybrid transformer apparatus and the control method thereof according to some embodiments is shown.

As shown in the FIG. 4, the system startup control flow includes the following steps:

Step S41: First, starting a module.

Step S42: After starting the module, short-circuiting the silicon controlled rectifier SCR, closing a relay so that a current flows through a bypass circuit, and ensuring system safety.

Step S43: Detecting fault signals such as a DC bus voltage, a power supply voltage (Vsource), and the metal oxide varistor MOV. If an abnormality (N) is detected, returning to step S42; if normality (Y) is detected, proceeding to step S44.

Step S44: Starting the parallel converter, aiming to establish the DC bus voltage to a predetermined voltage (for example, 400V), and then proceeding to step S45.

Step S45: Determining whether the DC bus voltage is greater than the predetermined voltage (for example, 400V). If the voltage is insufficient (N), returning to step S44 to continue waiting; if the voltage has reached the predetermined voltage (Y), proceeding to the next step S46.

Step S46: Starting the series converter and the compensation control loop, setting an initial compensation voltage target to, for example, 0V, starting to control switching of the first switching switch Q1 to the fourth switching switch Q4, short-circuiting the silicon controlled rectifier SCR, disconnecting the relay so that the current flows through the series converter for voltage compensation.

Step S47: Determining whether it is a phase zero point. If it is not the phase zero point (N), returning to step S46 to continue waiting; if it is the phase zero point (Y), proceeding to the next step S48.

Step S48: Performing over/undervoltage compensation, setting a target voltage to a target value (for example, 220V), starting slow startup so that the voltage smoothly rises to the target value, and proceeding to the next step S49.

Step S49: Ending.

Through the above flow, some embodiments in the disclosure can effectively start the hybrid transformer apparatus and ensure that the system operates in a safe and stable state, while achieving an accurate voltage compensation function and improving power supply quality.

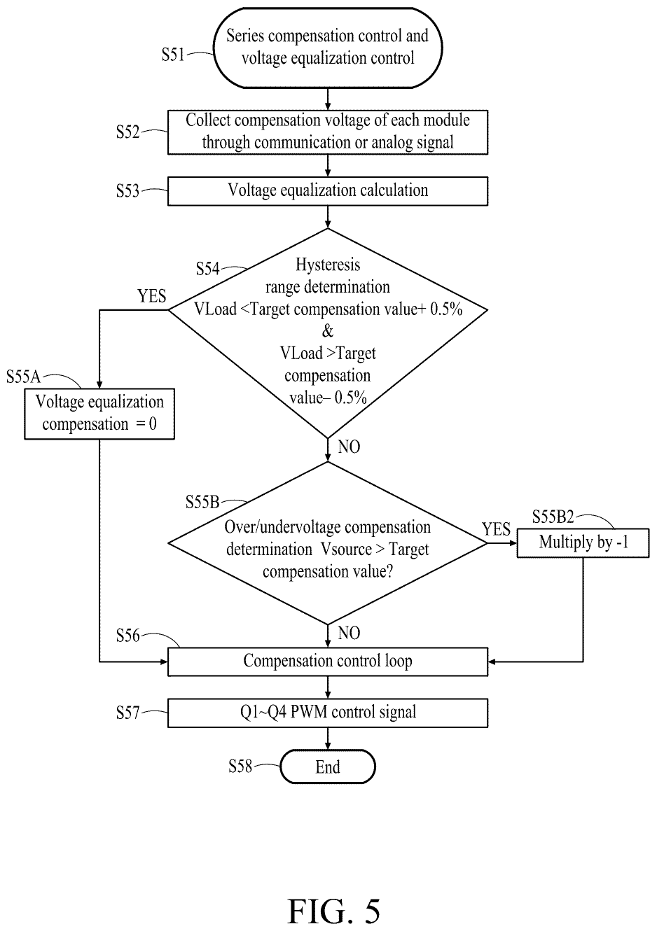

As shown in FIG. 5, a system compensation and voltage equalization control flow diagram of the hybrid transformer apparatus and the control method thereof according to some embodiments is shown.

As shown in the FIG. 5, the system compensation and voltage equalization control flow includes the following steps:

Step S51: First, starting series compensation control and voltage equalization control, and proceeding to the next step S52.

Step S52: Collecting a compensation voltage of each module through communication or an analog signal.

Step S53: Performing voltage equalization calculation, for example, comparing the compensation voltage of each module and selecting a maximum value as a reference command.

Step S54: Checking whether the load voltage V_{LOAD} exceeds a preset hysteresis range, for example, 220 Vrms±0.5%. If the load voltage exceeds the range (N), proceeding to step S55B; if the load voltage is within the range (Y), proceeding to step S55A.

Step S55A: Setting voltage equalization compensation to 0 and proceeding to the next step S56.

Step S55B: Performing over/undervoltage compensation determination, determining whether the power supply voltage (Vsource) is higher than 220 Vrms. If the power supply voltage is higher than 220 Vrms (Y), setting a compensation direction to −1 and proceeding to step S55B2; if the power supply voltage is not higher than 220 Vrms (N), proceeding to the next step S56.

Step S56: Executing the compensation control loop and proceeding to the next step S57.

Step S57: Generating a PWM control signal of the first switching switch Q1 to the fourth switching switch Q4, driving the series converter to perform voltage compensation, and proceeding to the next step S58.

Step S58: Ending.

Through the above flow, the disclosure can effectively coordinate operation of a plurality of power electronic modules, achieve accurate voltage compensation and load balancing, and improve system efficiency, stability, and module service life.

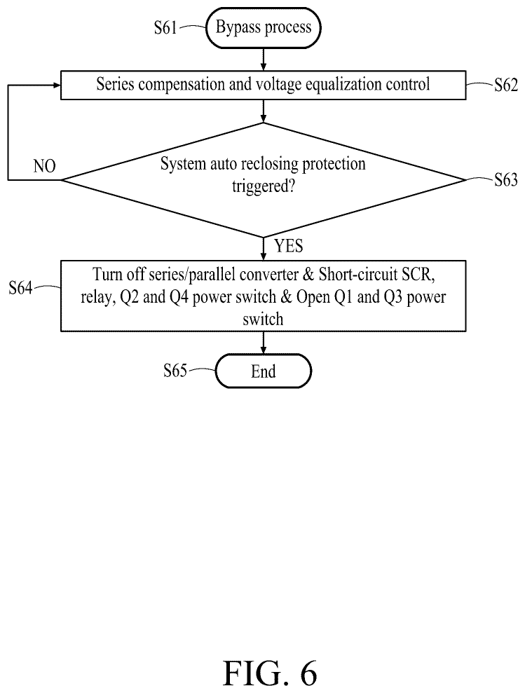

As shown in FIG. 6, a system bypass control flow diagram of the hybrid transformer apparatus according to some embodiments is shown.

As shown in the FIG. 6, the system bypass control flow includes the following steps:

Step S61: First, starting a bypass flow and proceeding to the next step S62.

Step S62: Performing series compensation and voltage equalization control, being ready to make the system enter a bypass mode at any time, and proceeding to the next step S63.

Step S63: Determining whether system automatic reclosing protection is triggered. If the system automatic reclosing protection is not triggered (N), returning to step S62; if the system automatic reclosing protection is triggered (Y), proceeding to step S64.

Step S64: Performing the following actions: turning off the series converter and the parallel converter, stopping voltage compensation and energy supply; short-circuiting the silicon controlled rectifier SCR so that a current directly flows through the bypass circuit, closing the relay to further ensure that the bypass circuit is turned on, closing the second switching switch Q2 and the fourth switching switch Q4 to provide an additional bypass path; disconnecting the first switching switch Q1 and the third switching switch Q3, isolating the series converter, and avoiding interference with the bypass circuit; proceeding to the next step S65.

Step S65: Ending.

Through the above configuration, when an abnormal condition occurs in the system, embodiments of the disclosure can activate a bypass function to achieve an effect of protecting the system and maintaining basic power supply.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hybrid transformer apparatus, comprising:
at least one power electronic module, comprising:
a parallel converter and a series converter electrically connected to each other to form a hybrid converter, the parallel converter being electrically connected to a low voltage side of a distribution transformer, and the series converter comprising a first switching switch, a second switching switch, a third switching switch, a fourth switching switch, and a compensation transformer;
a controller configured to control, based on a number of power electronic modules, signals of at least one of the first switching switch, the second switching switch, the third switching switch, and the fourth switching switch of the parallel converter and the series converter, a bypass circuit, and the compensation transformer, and reduce a variation in load voltage when a voltage input to the power electronic modules changes;
a communication device configured to transmit voltage and current information of at least one of the first switching switch, the second switching switch, the third switching switch, the fourth switching switch, the bypass circuit, and the compensation transformer to the controller; and
a circuit breaker configured to cut off an input power source of the power electronic modules;
wherein the bypass circuit comprises a relay, a silicon controlled rectifier (SCR), and a surge absorber (MOV), wherein the bypass circuit performs a fault protection operation when the hybrid converter fails based on switching speed characteristics of the elements, shorting the compensation transformer side to ensure normal energy transmission.

2. The hybrid transformer apparatus of claim 1, wherein the bypass circuit performs the shorting operation of the compensation transformer by the controller monitoring the voltage of the hybrid converter and determining whether an abnormality occurs, and when it is determined that an abnormality that can be regarded as a fault occurs, the controller closes at least one of the switches of the bypass circuit to bypass the hybrid converter.

3. The hybrid transformer apparatus of claim 1, wherein the hybrid converter further comprises sensors and monitoring equipment for monitoring operation of the hybrid transformer, the monitoring equipment is connected to one or more tap traditional transformers.

4. The hybrid transformer apparatus of claim 1, wherein a switch element of the bypass circuit receives a command issued by the controller, and performs a bypass or high-frequency switching operation of the switch in cooperation with a start or shutdown procedure of the controller.

5. The hybrid transformer apparatus of claim 1, wherein the power electronic module further comprises a first connection terminal, both ends of the circuit breaker are respectively connected in parallel to a first end point and a second end point of the low voltage side of the distribution transformer, both ends of the first connection terminal are electrically connected to both ends of the circuit breaker, and the circuit breaker is sequentially electrically connected to the first connection terminal and the parallel converter.

6. The hybrid transformer apparatus of claim 1, wherein the power electronic module further comprises a DC voltage bus and a first connection terminal, the parallel converter establishes a rated DC voltage to a positive end point and a negative end point of the DC voltage bus, the parallel converter is sequentially connected in parallel to the low voltage side and a feeder of the distribution transformer through the first connection terminal and the circuit breaker, and the parallel converter is electrically connected to the first connection terminal, the DC voltage bus, and the series converter.

7. The hybrid transformer apparatus of claim 1, wherein the power electronic module further comprises a DC voltage bus, a positive end point of the DC voltage bus is electrically connected to a drain of the first switching switch and a drain of the third switching switch, and a negative end point of the DC voltage bus is electrically connected to a source of the second switching switch and a source of the fourth switching switch.

8. The hybrid transformer apparatus of claim 1, wherein a source of the first switching switch is electrically connected to a drain of the second switching switch, a drain of the first switching switch is electrically connected to the drain of the third switching switch, the source of the second switching switch is electrically connected to a source of the fourth switching switch, a source of the third switching switch is electrically connected to a drain of the fourth switching switch, and the first switching switch to the fourth switching switch form an H-bridge switch structure.

9. The hybrid transformer apparatus of claim 1, wherein the power electronic module further comprises a DC voltage bus, the controller receives an operation signal of the parallel converter to monitor whether the parallel converter is operating normally according to the operation signal, and the controller monitors whether the parallel converter has established a rated DC voltage on the positive end point and the negative end point of the DC voltage bus.

10. A control method for a hybrid transformer apparatus, wherein the controller included in the hybrid transformer apparatus of claim 1 is caused to perform the following steps:
a voltage equalization calculation step of using a peak command detection method to find a maximum voltage value in the power electronic modules, using the maximum voltage value as a reference command voltage followed by each of the power electronic modules, and obtaining a voltage feedback value for each of the power electronic modules, and comparing the voltage feedback value with the reference command voltage;
an undervoltage/overvoltage determination step of performing a calculation with an effective value of the voltage feedback value, then determining whether an undervoltage condition or an overvoltage condition exists, and adjusting a compensation command value according to a determination result; and
a compensation control step of individually activating the series converter in the power electronic modules and a compensation control loop according to a result of the undervoltage/overvoltage determination step.

11. The control method of claim 10, further comprising:
using the controller to monitor the voltage of the hybrid converter and to determine whether an abnormality occurs; and
bypassing the hybrid converter by closing at least one of the switches of the bypass circuit when it is determined that an abnormality that can be regarded as a fault occurs.

12. The control method of claim 10, wherein the hybrid converter further comprises:
sensors configured to monitor operation of the hybrid transformer; and
monitoring equipment connected to the one or more tap traditional transformers.

13. The control method of claim 10, further comprising:
using the controller to control a switch element of the bypass circuit to perform a bypass or high-frequency switching behavior of the switch in cooperation with a start and shutdown procedure of the controller.

14. The control method of claim 10, wherein the power electronic module further comprises:
a first connection terminal;
wherein both ends of the circuit breaker are respectively connected in parallel to a first end point and a second end point of the low voltage side of the distribution transformer, both ends of the first connection terminal are electrically connected to both ends of the circuit breaker, and the circuit breaker is sequentially electrically connected to the first connection terminal and the parallel converter.

15. The control method of claim 10, wherein the power electronic module further comprises:
a DC voltage bus and a first connection terminal;
wherein the parallel converter establishes a rated DC voltage to a positive end point and a negative end point of the DC voltage bus, the parallel converter is sequentially connected in parallel to the low voltage side and a feeder of the distribution transformer through the first connection terminal and the circuit breaker, and the parallel converter is electrically connected to the first connection terminal, the DC voltage bus, and the series converter.

16. The control method of claim 10, wherein the power electronic module further comprises:
a DC voltage bus;
wherein a positive end point of the DC voltage bus is electrically connected to a drain of the first switching switch and a drain of the third switching switch, and a negative end point of the DC voltage bus is electrically connected to a source of the second switching switch and a source of the fourth switching switch.

17. The control method of claim 10, wherein a source of the first switching switch is electrically connected to a drain of the second switching switch, a drain of the first switching switch is electrically connected to the drain of the third switching switch, the source of the second switching switch is electrically connected to a source of the fourth switching switch, a source of the third switching switch is electrically connected to a drain of the fourth switching switch, and the first switching switch to the fourth switching switch form an H-bridge switch structure.

18. The control method of claim 10, wherein the power electronic module further comprises:
a DC voltage bus;
wherein the controller receives the operation signal of the parallel converter to monitor whether the parallel converter is operating normally according to the operation signal, and the controller monitors whether the parallel converter has established a rated DC voltage on the positive end point and the negative end point of the DC voltage bus.
